(19) United States
(12) Patent Application Publication
(10) Pub. No.: US 2021/0307307 A1
(43) Pub. Date: Oct. 7, 2021

(54) Fishing Lure

(71) Applicant: Jarrod Deaton, Canberra (AU)

(72) Inventors: Jarrod Deaton, Canberra (AU); Scott Tipping, Brisbane (AU)

(73) Assignee: Jarrod Deaton, Canberra (AU)

(21) Appl. No.: 17/268,979

(22) PCT Filed: Aug. 30, 2019
(86) PCT No.: PCT/AU2019/050923

§ 371 Date: Feb. 17, 2021

(30) Foreign Application Priority Data
Aug. 31, 2018 (AU) 2018903228

(51) Int. Cl. A01K 85/18

(52) U.S. Cl. CPC A01K 85/18

(57) ABSTRACT

When selecting a fishing lure it can be important to select one with a suitable appearance. Embodiments of the present invention provide a fishing lure comprising a body and a cover removably attached thereto, the cover being interchangeable with a second removable cover such that an appearance of the lure can be changed.

### FIELD OF THE INVENTION

Embodiments of the present invention relate to a fishing lure.

### BACKGROUND OF THE INVENTION

Fishing lure selection plays a significant role in fishing and can determine how successful a fisher is at catching fish. An important consideration when selecting a fishing lure is choosing one with an appropriate visual appearance.

Different fish can be more inclined to see certain colours over others, and/or are more drawn towards lures that resemble one type of bait over others. Moreover, the manner in which fish perceive a lure can vary based on a number of factors, including the clarity of the water, the depth to which the lure is cast, and weather conditions. As such, it is important to select a fishing lure that can be seen by, and is attractive to, the type of fish that one wishes to catch.

The movement and diving characteristics of a fishing lure are also important considerations when selecting which lure to use. An effective fishing lure should be able to operate at a depth at which the target fish are swimming or can see. Moreover, as a fishing lure travels through the water, its movement should catch the attention of the target fish. Ideally, the fishing lure should look and move like the natural food that the target fish is attracted to. The movement and diving characteristics of a fishing lure can be controlled by selecting a fishing lure with an appropriate “bib”. The bib of a fishing lure refers to a plate-like lip projecting from the head of a lure. The geometry of a bib influences a fishing lure's movement and the depth to which the lure can dive. For example, bibs of certain geometries will cause the lure to “shimmy” as it travels through water, mimicking the appearance of a small fish swimming quickly.

Given the importance of fishing lure selection, it is common for fisher's to carry with them an assortment of different fishing lures, each having different visual appearances and/or bibs. Also, given that fishing conditions are prone to change (e.g. the water is murkier than expected; clouds have rolled in to block out the sun; the fishing location has changed; the type of fish being targeted has changed), fishers often change their fishing lures to adjust for changing conditions. Changing fishing lures can be relatively time and labour-intensive, involving untying and retying knots in order to replace one lure with another on one's fishing line. Constantly attaching and detaching fishing lures also increases the likelihood that a lure is inadvertently dropped into the water and thus lost. Moreover, time spent changing lures reduces the amount of time the fisher is actually fishing. It can also be relatively burdensome to purchase, maintain and transport a wide range of fishing lures with different appearances and/or bibs to suit changing fishing conditions.

It is desired to overcome or alleviate one or more difficulties of existing fishing lures, or to at least provide a useful alternative.

### SUMMARY OF THE INVENTION

The present invention provides a fishing lure comprising a body and a cover removably attached thereto, the cover being interchangeable with a second removable cover such that an appearance of the lure can be changed. As such, the appearance of the lure, such as the lure's pattern and colour, can easily be changed by simply interchanging one removable cover with another removable cover of a different pattern and/or colour. In this way, if one wants to alter the appearance of their fishing lure, one does not need to remove the entire fishing lure from one's fishing line and swap it out for an entirely different fishing lure. Accordingly, one also need not keep at hand a range of fishing lures with different appearances; one can simply use a single fishing lure with a range of different covers of varying appearances.

Preferably, the fishing lure comprises an removable bib which is interchangeable with a second removable bib. As such, bibs of different geometries can be readily interchanged with one another so as to adjust the fishing lure's movement and/or diving depth to the fisher's preferences. Accordingly, the in-water movement characteristics of the fishing lure can simply be adjusted by interchanging bibs on the same fishing lure without needing to detach the fishing lure from one's fishing line.

In an embodiment, the cover and the bib are configured to engage one another such that removal of one permits removal of the other. For example, the cover may be configured to removably secure the bib such that removal of the cover permits removal of the bib. This engagement between the interchangeable cover and interchangeable bib may simplify the construction and/or ease of use of the fishing lure.

In an embodiment, the cover comprises a projection configured to extend into the body, and the bib comprises an aperture for engaging the projection, such that in use, engagement between the projection and the aperture secures the bib. The projection can take the form of, for example, a pin or stud, and provides a simple method of securing both the cover and bib to the body.

In an embodiment, the body comprises an opening for receiving the projection of the cover. In use, the aperture of the secured bib is aligned with the opening of the body such that the projection of the cover extends through the opening of the body and into the aperture of the bib, thereby securing the bib to the body. As such, the simple action of inserting the projection into the opening of the body facilitates the removable attachment of both the cover and the bib to the body.

In an embodiment, the cover comprises opposed sidewalls configured to slide over the body when attaching the cover thereto. The cover may be resiliently deformable and configured to squeeze over the body to retain the cover thereon.

For example, the cover may define an opening between its opposed sidewalls which is slightly smaller than the size of the body. In this case, the cover must resiliently deform and stretch open slightly to receive the body. The cover thus squeezes over the body, and this compressing action helps secure the cover to the body.

In an embodiment, the lure comprises a recess formed between the cover and the body to facilitate manual removal of the cover from the body. For example, the recess may permit the cover to be manually pried off the body. Such an embodiment provides users with an intuitive and easy way to swap one cover and/or bib with another cover and/or bib, respectively.

In an embodiment, the cover and the body are configured to engage one another via a complementary tongue and groove engagement. This type of connection is simple to construct and provides an effective means for both retaining the cover on the body and removing the cover from the body.

In an embodiment, the cover covers a substantial portion of the body. As such, the overall appearance of the lure can be changed by simply swapping one cover for another.

In an embodiment, the cover comprises segments which are removably attachable to the body. For example, one segment could attach to a head of the body, another segment could attach to one side of the body, and another segment could attach to a tail of the body. In this way, the appearance of the lure can be changed by interchanging one or more segments with other respective segments.

In an embodiment, the fishing lure is a plug lure.

### BRIEF DESCRIPTION OF THE DRAWINGS

Embodiments of the invention are further described, by way of example only, with reference to the accompanying drawings in which:

FIG. 1 is a side view of a fishing lure according to an embodiment of the present invention;

FIG. 2 is an exploded side perspective view of the fishing lure of FIG. 1;

FIG. 3 is a cross sectional side view of the fishing lure of FIG. 1;

FIG. 4 is a cross sectional front view of the fishing lure of FIG. 1; and

FIG. 5 is a side view of the fishing lure of FIG. 1, with attachments.

### DETAILED DESCRIPTION

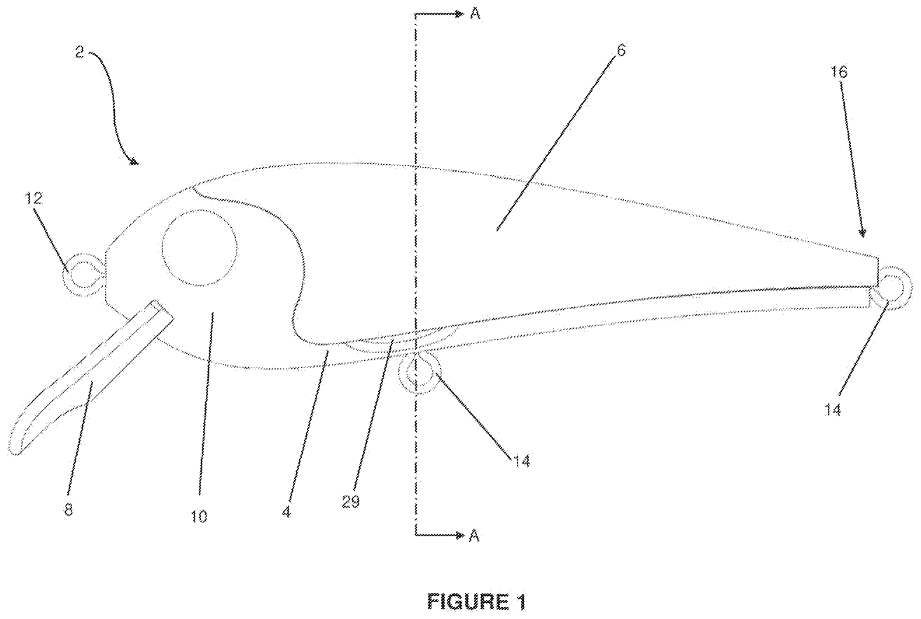

FIG. 1 shows a fishing lure 2 comprising a body 4 and a cover 6 that is removably attached to the body 4. The cover 6 is interchangeable with other removable covers such that the appearance of the fishing lure 2 can be changed by swapping one 6 cover for another cover 6, thereby negating the need to swap an entire fishing lure with another fishing lure.

The fishing lure 2 also comprises a bib 8 which is removably attached at a head 10 of the body 4. The bib 8 is interchangeable with other bibs 8 such that the movement and diving characteristics of the fishing lure 2 can be altered simply by swapping one bib 8 for another bib 8, thereby negating the need to swap one fishing lure with one bib for another fishing lure with another bib.

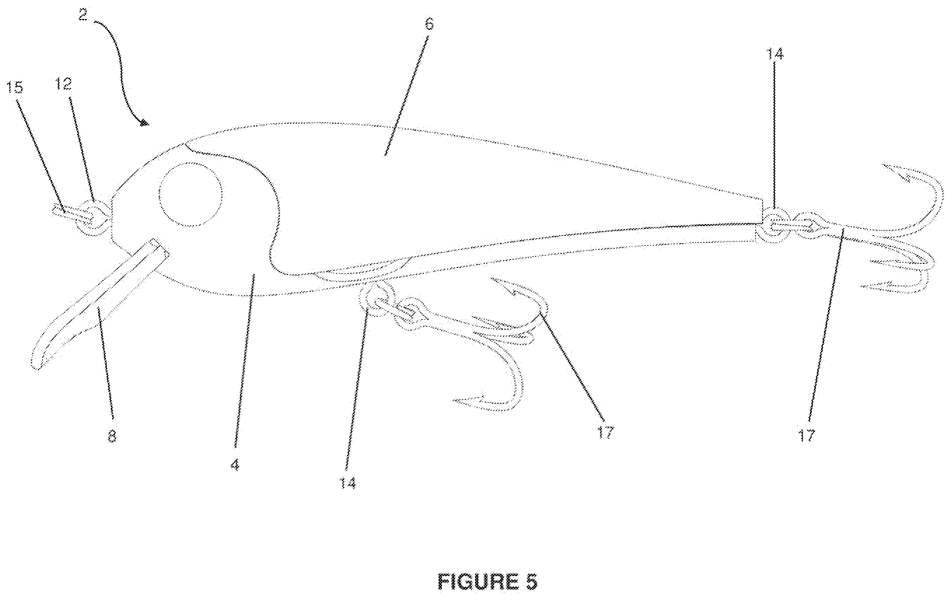

The fishing lure 2 depicted in the figures is of a type known as “plug lures”. While the present description is in the context of plug lures, the disclosure herein is of course applicable and adaptable to other types of fishing lures. The depicted plug lure 2 is relatively rigid, and, with reference to FIG. 5, is equipped with a front attachment ring 12 via which the lure 2 can be secured to a fishing line 15. The lure 2 also comprises attachment rings 14 extending from a lower end of the lure 2 and from a tail end 16 of the lure 2. With reference to FIG. 5, hooks 17 are secured to these attachment rings 14 so that bait can be hooked on to the fishing lure 2. The fishing line 15 and hooks 17 are absent from FIGS. 1 to 4 for simplicity.

The fishing lure 2 shown in the Figures is in the form of a narrow and elongate fish which can attract certain target fish. The disclosure herein is of course applicable and adaptable to fishing lures of other forms and designs.

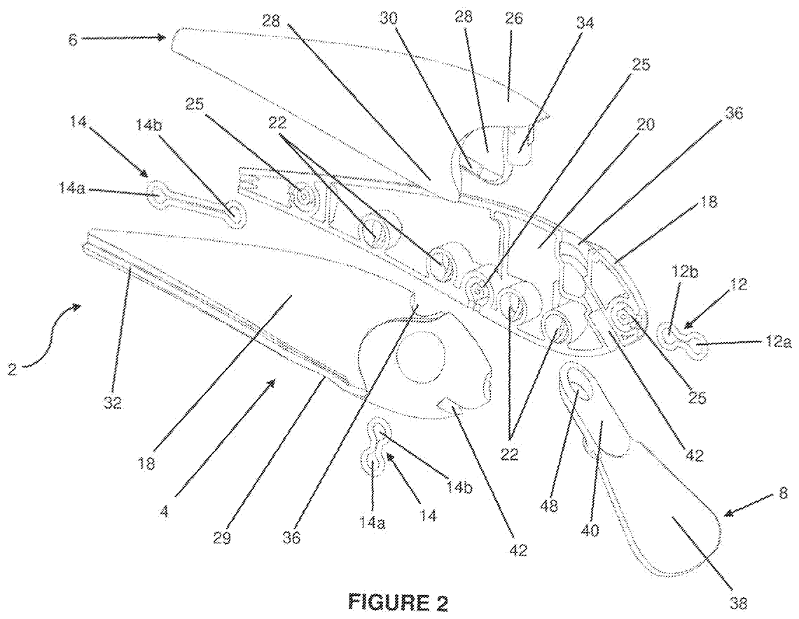

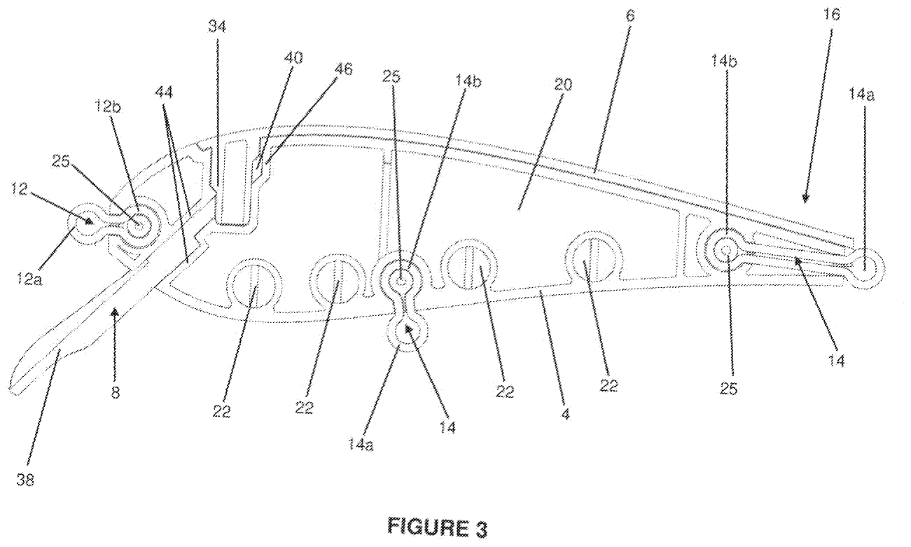

FIG. 2 is an exploded view of the fishing lure 2. The body 4 comprises two elongate halves 18 which define a cavity 20 therebetween. The elongate halves 18 are fixed to one another to form a unitary body 4 of the fishing lure 2; the elongate halves 18 are shown separate from one another in FIG. 2 to illustrate the internal construction of the body 4. The elongate halves 18 of the body 4 may be ultrasonically welded together to seal against entry of water into the cavity 20. The cavity 20 may house weights, ball bearings, and other accessories for altering the performance of the fishing lure 2. To this end, the interior of the body 4 comprises spherical hollow spaces 22 into which weights such as ball bearings can be inserted and contained. These hollow spaces 22 are also shown in the cross sectional side view of FIG. 3.

The exploded view of FIG. 2 shows that the attachment rings 12, 14 are generally symmetrical; each resembles an elongated figure eight and comprises an external ring structure 12a, 14a arranged for attachment to a fishing line and hook, respectively, and opposite internal ring structures 12b, 14b configured to secure each attachment ring 12, 14 to the fishing lure 2. To this end, the interior of the body 2 comprises attachment points in the form of projections 25 which extend across the cavity 20 defined by the body halves 18. The projections 25 are configured to extend through the internal ring structures 12b, 14b when the lure 2 is assembled, thereby securing the attachment rings 12, 14 to the fishing lure 2.

The fishing lure 2 comprises a cover 6 which is attachable to the body 4 like a detachable shell. The cover 6 defines an external appearance of a substantial portion of the fishing lure 2. The cover 6 is formed as a unitary piece having a curved upper wall 26 which fits over the body 4 of the fishing lure 2, and two downwardly extending and opposed sidewalls 28 arranged to close around respective sides of the body 4 of the fishing lure 2.

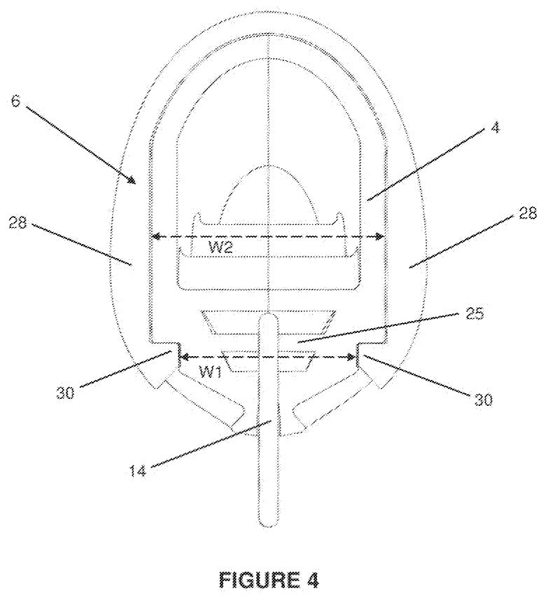

Referring to FIG. 4, an interior and lower end of the opposed sidewalls 28 of the cover 6 is provided with inwardly protruding tongues 30. Correspondingly, a lower end of each side of the body 4 of the fishing lure 2 is provided with an elongate and complementary groove 32, as shown in FIG. 2.

Referring to FIG. 2, to attach the cover 6 to the body 4, the cover 6 is slid onto the body 4 from above such that each tongue 30 of the cover 6 is received by and engages a respective groove 32 of the body 4. This tongue 30 and groove 32 connection helps clip the cover 6 to the body 4 of the fishing lure 2. Furthermore, the positive clipping and locking of each tongue 30 into a respective groove 32 provides tactile and/or auditory feedback to the user to confirm that the cover 6 has been properly attached to the body 4 of the fishing lure 2.

Referring to FIG. 4, it can be seen that the width W1 between the opposed tongues 30 of the cover 6 is less than a maximum width W2 of the exterior of the body 4. As such, as the cover 6 is slid onto and over the body 4, the body 4 urges the opposed sidewalls 28 away from one another. The cover 6 is formed from a resiliently deformable material, such as a relatively rigid plastic. Consequently, when the opposed sidewalls 28 of the cover 6 are urged away from one another, the cover 6 assumes a stressed state whereby the sidewalls 28 are biased to return toward one another; the opposed sidewalls 28 thus squeeze the external walls of the body 4 of the fishing lure 2.

As the cover 6 continues to be slid onto the body 4 of the fishing lure 2, the tongues 30 of the cover 6 clip into respective grooves 26 of the body 4, and the cover 6 resumes an unstressed state in which its opposed sidewalls 28 are no longer urged away from one another.

To remove the cover 6 from the body, the opposed sidewalls 28 must be manually spread away from one another to allow the tongues 30 of the cover to be dislodged from the respective grooves 26 of the body 4. This type of connection between the cover 6 and the body 4 provides an effective and simple means for securing the cover 6 to the body 4. This type of connection also provides a relatively simple means for removing the cover 6 from the body 4 so that different covers 6 can be easily interchanged with one another in order to alter the appearance of the fishing lure 2.

Referring to FIGS. 1 and 2, the fishing lure 2 comprises lateral recesses 29 formed between the cover 6 and the body 4. The recesses 29 are manually accessible to a user even when the cover 6 is attached to the body 4. The recesses 29 allow a user to manually remove the cover 6 from the body 4. In particular, the recesses 29 expose and thus grant manual access to an interior of each opposed sidewall 28 of the cover 6. A user can thus position a thumb at each recess 29, and one or more fingers on the head 10 of the body 4, and pry the cover 6 off the body 4. In this way, the user can easily and quickly remove a cover 6 of the fishing lure 2 and replace it with another cover 6 so as to change the appearance of the fishing lure 2.

While the cover 6 can be utilised with fishing lures with fixed bibs, the cover 6 can also cooperate with interchangeable bibs 8. To this end, and with reference to FIGS. 2 and 3, the cover 6 comprises a projection, depicted as a pin 34, which extends downwardly from an frontal interior of the curved upper wall 26 of the cover 6. The upper end of the head 10 of the body 4 is provided with a corresponding opening 36 for receiving the pin 34. The pin 34 may thus be inserted into the opening 36 so that the pin 34 extends through and into the body 4 of the fishing lure 2, thereby helping to secure the cover 6 to the body 4.

The pin 34 also removably secures an interchangeable bib 8 to the fishing lure 2. To this end, the bib 8 is in the form of a thin and elongate tab-like structure, having a distal end 38 arranged to interact with water, and a proximal end 40 arranged to engage with the pin 34 and the body 4 of the fishing lure 2. The interior of the body 4 comprises a slot 42 into which the proximal end 40 of the bib 34 can be inserted. In use, the distal end 38 of the bib 8 projects out from the head 10 of the body 4 and interacts with surrounding water to influence the fishing lure's 2 movement and diving characteristics.

Referring to FIGS. 2 and 3, the slot 42 is defined by a pair of angled walls 44 which lead to an internal transverse wall 46 of the body 4. As the bib 8 is slid into the slot 42, physical contact between the proximal end 40 of the bib 8 and the transverse wall 46 stops the bib 8 from being slid into the body 4 any further. Moreover, the physical contact between the transverse wall 46 and the bib 8 provides tactile feedback to the user that the bib 34 has been sufficiently slid into the slot 42 and is correctly positioned within the body 4 of the fishing lure 2.

Referring to FIG. 2, the proximal end 40 of the bib 8 comprises an aperture 48 for receiving the pin 34 of the cover 6. When the bib 8 is slid into place via the slot 42 (i.e. the proximal end 40 of the bib 8 makes physical contact with the transverse wall 46), the aperture 48 of the bib is aligned with the opening 36 of the body 4. In this way, as the cover 6 is slid onto the body 4, the pin 34 of the cover 6 extends through both the opening 36 of the body 4 and the aperture 48 of the bib 8. Upon clipping the cover 6 into place via the tongue 30 and groove 32 connection, the cover 6 attaches to the body 4 and the pin 34 of the cover 6 retains the bib 8 within the slot 42 of the body 4. Similarly, removal of the cover 6 from the body 4 enables removal of the bib 34 from the slot 42, thereby allowing the user to slide the bib 8 out from the slot 42 and swap it with another bib 8. As such, the cover 6 and the bib 8 can be interchanged with other covers 6 and bibs 8, respectively, in order to effect the appearance, movement and diving characteristics of the fishing lure 2.

It should be noted that the cover 6 need not comprise a single unitary piece that covers a substantial portion of the body 4. For example, the cover could comprise one or more distinct segments which attach to the body 4. For example, one segment could attach to the head 10 of the body 4, and another segment could attach to a rear of the body 4. In this way, even relatively minor changes to the appearance of the fishing lure 2 can be effected simply by swapping out one segment of the cover for another segment without needing to detach the fishing lure 2 from the fishing line.

Additionally, the mechanism for attaching the cover 6 to the body 4 of the fishing lure 2 may vary from what is shown in the Figures. For example, the cover 6 may comprise a pin with a resiliently deformable and enlarged head which forms an interference fit with a suitably-sized aperture provided in the body 4.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

1. A fishing lure comprising a body and a cover removably attached thereto, the cover being interchangeable with a second removable cover such that an appearance of the lure can be changed.

2. The lure of claim 1, further comprising a removable bib which is interchangeable with a second removable bib.

3. The lure of claim 2, wherein the cover and the bib are configured to engage one another such that removal of one permits removal of the other.

4. The lure of claim 3, wherein the cover is configured to removably secure the bib, such that removal of the cover permits removal of the bib.

5. The lure of claim 3 or 4, wherein the cover comprises a projection configured to extend into the body, and the bib comprises an aperture for engaging the projection, such that in use, engagement between the projection and the aperture secures the bib.

6. The lure of claim 5, wherein the body comprises an opening for receiving the projection, and wherein in use, the aperture of the secured bib is aligned with the opening of the body such that the projection of the cover extends through the opening of the body and the aperture of the bib, thereby securing the bib to the body.

7. The lure of any one of the preceding claims, wherein the cover comprises opposed sidewalls configured to slide over the body when attaching the cover thereto.

8. The lure of claim 7, wherein the cover is resiliently deformable and configured to squeeze over the body to retain the cover thereon.

9. The lure of any one of the preceding claims, further comprising a recess formed between the cover and the body to facilitate manual removal of the cover from the body.

10. The lure of claim 9, wherein the recess permits the cover to be manually pried off the body.

11. The lure of any one of the preceding claims, wherein the cover and the body are configured to engage one another via a complementary tongue and groove engagement.

12. The lure of any one of the preceding claims, wherein the cover covers a substantial proportion of the body.

13. The lure of any one of the preceding claims, wherein:
the cover comprises segments which are removably attachable to the body; and
the appearance of the lure can be changed by interchanging one or more segments with other respective segments.

14. The lure of any one of the preceding claims, wherein the lure is a plug lure.
